(19) United States
(12) Patent Application Publication
(10) Pub. No.: US 2008/0183684 A1
(43) Pub. Date: Jul. 31, 2008

(54) Caching an Access Plan for a Query

(76) Inventors: Robert J. Bestgen, Rochester, MN (US); Michael S. Faunce, Rochester, MN (US); Wei Hu, Rochester, MN (US); Shantan Kethireddy, Rochester, MN (US); Andrew P. Passe, Rochester, MN (US); Ulrich Thiemann, Rochester, MN (US)

Correspondence Address: IBM (ROC-BLF), C/O BIGGERS & OHANIAN, LLP, P.O. BOX 1469, AUSTIN, TX, 78767-1469, US

(21) Appl. No.: 11/627,672

(22) Filed: Jan. 26, 2007

(51) Int. Cl. G06F 17/30

(52) U.S. Cl. 707/4; 707/E17.017

(57) ABSTRACT

Methods, apparatus, and products are disclosed for caching an access plan for a query that include: receiving, in a SQL module of a DBMS, a SQL query that specifies data for retrieval from a database, the database characterized by database statistics, the SQL query characterized by one or more host variable values; generating, by the SQL module, an access plan in dependence upon the SQL query; calculating, by the SQL module, a routing code for the SQL query in dependence upon the host variable values of the SQL query and a portion of the database statistics; and storing, by the SQL module, the access plan in an access plan cache, including associating with the access plan the routing code for the SQL query and the portion of the database statistics used to calculate the routing code.

### BACKGROUND OF THE INVENTION

1. Field of the Invention

The field of the invention is data processing, or, more specifically, methods, apparatus, and products for caching an access plan for a query.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. The most basic requirements levied upon computer systems, however, remain little changed. A computer system's job is to access, manipulate, and store information. Computer system designers are constantly striving to improve the way in which a computer system can deal with information.

Information stored on a computer system is often organized in a structure called a database. A database is a collection of related data and metadata. Metadata is data that describes other data such as, for example, data statistics. The data of a database is typically grouped into related structures called ‘tables,’ which in turn are organized in rows of individual data elements. The rows are often referred to a ‘records,’ and the individual data elements are referred to as ‘fields’ or ‘columns.’ In this specification generally, therefore, an aggregation of fields is referred to as a ‘record’ or a ‘data structure,’ and an aggregation of records is referred to as a ‘table.’

The metadata of a database typically includes schemas, table indexes, and database statistics. A schema is a structural description of the data in the database. A schema typically defines the columns of a table, the data types of the data contained in each column, which columns to include in an index, and so on. An index is a database structure used to optimize access to the rows in a table. An index is typically smaller than a table because an index is created using one or more columns of the table, and an index is optimized for quick searching, usually via a balanced tree. Database statistics describe the data in tables of a database. Database statistics may describe, for example, the number of records having a particular value for a particular field. As with the data of a database, metadata is often stored in tables of the database.

A computer system typically operates according to computer program instructions in computer programs. A computer program that supports access to information in a database is typically called a database management system or a ‘DBMS.’ A DBMS is computer software that is responsible for helping other computer programs access, manipulate, and save information in a database. A DBMS often utilizes metadata of the database for accessing and manipulating data of the database.

A DBMS typically supports access and management tools to aid users, developers, and other programs in accessing information in a database. One such tool is the structured query language (‘SQL’). A query is a request for information from a database. SQL is a language for specifying a query. Although there is a standard of the American National Standards Institute (‘ANSI’) for SQL, as a practical matter, most versions of SQL tend to include many extensions that are customized by various DBMS vendors.

Users may access data in a database by typing a SQL query into a graphical user interface (‘GUI’) of a DBMS and immediately viewing the results after the query is executed. As a practical matter, however, most SQL queries are embedded in a host application that provides the SQL queries to the DBMS through a data communications connection implemented, for example, according to the Open Database Connectivity (‘ODBC’) specification, the Java Database Connectivity (‘JDBC’) specification, some other database connectivity specification.

A host application is so termed because the application, which is written in a language other than SQL, hosts blocks of instructions written according to SQL. The SQL queries embedded in a host application often include variables used throughout the host application. These variables are referred to generally as host variables. The host variables are used by the host application and the DBMS to specify a variety of datasets using the same SQL query. For example, consider the following embedded query expressed in SQL:
select*from stores, transactions
where stores.location=:CITY
and stores.storeID=transactions.storeID

The exemplary SQL query above accesses information in a database by selecting records from two tables of the database, one table named ‘stores’ and another table named ‘transactions.’ The records selected are those having a value for their store location field that matches the host variable value for the host variable ‘CITY’ and having transactions for the stores in the city specified by the host variable ‘CITY.’ By altering the value for the host variable ‘CITY,’ a host application may specify records for stores in different cities using the same SQL query. From the example of above, readers will note that host variables may be defined as variables for column values. In the example above, the host variable ‘CITY’ specifies a column value for the column ‘location’ in the ‘stores’ table.

To retrieve the results for a SQL query, a DBMS generates a number of ‘primitive queries,’ each primitive query used to retrieve a portion of the data needed to satisfy the SQL query. In retrieving the data for the exemplary SQL query above, DBMS will first retrieve records from the stores table and then use another primitive query to retrieve records from the transaction table. Records that satisfy the query requirements then are merged in a ‘join’ and returned as a result of the exemplary SQL query above received by the DBMS. The combination of primitive queries and the join operation described above constitute the database operations used to carry out a SQL query.

A SQL module specifies the database operations and the sequence in which those operations are carried out for each SQL query in an access plan. Generating an access plan for each query, however, is a computationally expensive process. The DBMS must evaluate the query and determine the most efficient database operations for retrieving the query results. To mitigate the computing resources required to create an access plan, a DBMS typically saves an access plan in an access plan cache for later reuse in the event that a host application reissues the same SQL query. Such cached access plans often allow for efficient execution of repeated queries.

The drawback to current access plan caching schemes is that no computationally inexpensive mechanism exists for a DBMS to determine whether a cached access plan should be reused for a SQL query having changed host variable values. For example, consider the exemplary SQL query above for which a DBMS generated an access plan when the value for the host variable ‘CITY’ is ‘Rochester.’ Consider also that a host application reissues the same exemplary SQL query when the value for the host variable ‘CITY’ is changed to ‘Austin.’ Current database management systems do not include a computationally inexpensive mechanism to determine whether the stored access plan generated using the host variable value ‘Rochester’ is optimized for retrieving results when the host variable value is changed to ‘Austin.’ Such database management systems in the current art either simply ignore any changes in host variable values and reuse the stored access plan or perform computationally expensive selectivity calculations using the new host variable values to determine whether a stored access plan should be reused. Both of these current art approaches result in inefficient use of cached access plans. As such, readers will therefore appreciate that room for improvement exists in caching an access plan for a query.

### SUMMARY OF THE INVENTION

Methods, apparatus, and products are disclosed for caching an access plan for a query that include: receiving, in a SQL module of a DBMS, a SQL query that specifies data for retrieval from a database, the database characterized by database statistics, the SQL query characterized by one or more host variable values; generating, by the SQL module, an access plan in dependence upon the SQL query; calculating, by the SQL module, a routing code for the SQL query in dependence upon the host variable values of the SQL query and a portion of the database statistics; and storing, by the SQL module, the access plan in an access plan cache, including associating with the access plan the routing code for the SQL query and the portion of the database statistics used to calculate the routing code.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an exemplary system for caching an access plan for a query according to embodiments of the present invention.

FIG. 2 sets forth a block diagram of automated computing machinery comprising an exemplary computer useful in caching an access plan for a query according to embodiments of the present invention.

FIG. 3 sets forth a flow chart illustrating an exemplary method for caching an access plan for a query according to embodiments of the present invention.

FIG. 4 sets forth a flow chart illustrating a further exemplary method for caching an access plan for a query according to embodiments of the present invention.

FIG. 5 sets forth a flow chart illustrating an exemplary method for determining, by the SQL module, whether to utilize a stored access plan for the additional SQL query that is useful in caching an access plan for a query according to embodiments of the present invention.

### DETAILED DESCRIPTION OF EXEMPLARY EMBODIMENTS

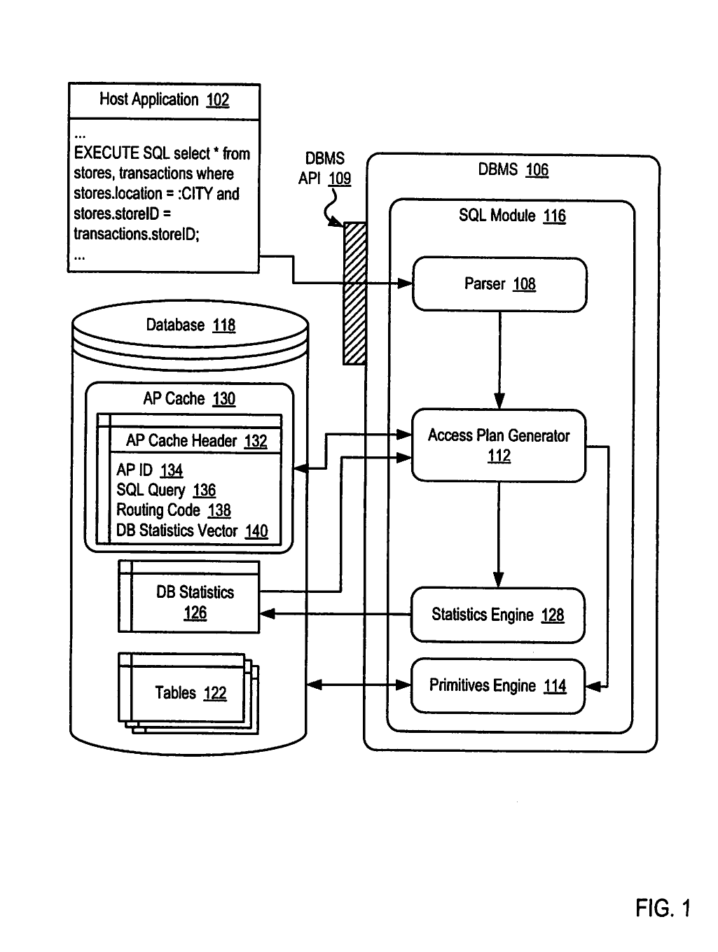

Exemplary methods, apparatus, and products for caching an access plan for a query in accordance with the present invention are described with reference to the accompanying drawings, beginning with FIG. 1. FIG. 1 sets forth a block diagram of an exemplary system for caching an access plan for a query according to embodiments of the present invention. The exemplary system of FIG. 1 generally operates for caching an access plan for a query according to embodiments of the present invention as follows: A SQL module (116) of a DBMS (106) receives a SQL query that specifies data for retrieval from a database (118). The database (118) is characterized by database statistics (126). The SQL query is characterized by one or more host variable values. The SQL module (116) generates an access plan in dependence upon the SQL query. The SQL module (116) calculates a routing code for the SQL query in dependence upon the host variable values of the SQL query and a portion of the database statistics (126). The SQL module (116) stores the access plan in an access plan cache (130), including associating with the access plan the routing code for the SQL query and the portion of the database statistics (126) used to calculate the routing code.

The exemplary system of FIG. 1 also operates for caching an access plan for a query according to embodiments of the present invention as follows: The SQL module (116) receives an additional SQL query characterized by one or more additional host variable values. The SQL module (116) determines whether to utilize a stored access plan for the additional SQL query in dependence upon the additional host variable values, the routing code associated with the stored access plan, and the portion of the database statistics associated with the stored access plan. The SQL module (116) executes the stored access plan for the additional SQL query or generates a new access plan for the additional SQL query in dependence upon the determination of whether to utilize the stored access plan for the additional SQL query.

A routing code for a SQL query is an identifier that categorizes the query, based on the query's host variable values, in one of a plurality of possible categories that apply to queries having matching textual representations and host variables. For example, consider the following SQL query embedded in a host application:
select*from stores
where stores.location=:CITY
and stores.sales>:SALES.

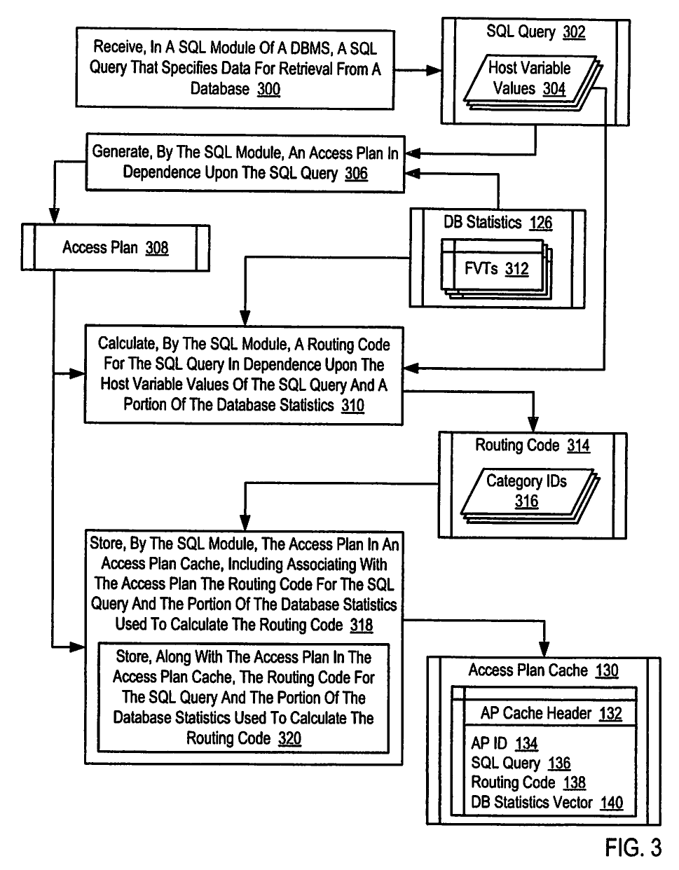

When a processor executes the computer code in the host application containing the exemplary query above multiple times, the SQL module (116) receives identical queries, but with potentially different host variable values for the host variables ‘CITY’ and ‘SALES.’ Even though each query is identical, the SQL module (116) may calculate a different routing code for each query based on each query's host variable values for ‘CITY’ and ‘SALES.’ The SQL module (116) may efficiently use an access plan generated using a SQL query characterized by one set of host variable for an identical SQL query when characterized by a different set of host variable values provided that both queries have the same routing code. When the queries do not have the same routing code, however, a single access plan typically is not efficiently utilized for both queries even though the queries are identical. Routing codes will be discussed in more detail below with reference to FIG. 3.

In the exemplary system of FIG. 1, the SQL module (116) is one of many software components included a DBMS (106). The DBMS (106) of FIG. 1 provides access tools and management tools to aid users, developers, and other programs in accessing the data stored in tables (122) of the database (118). The SQL module (116) of FIG. 1 is implemented as computer program instructions that execute a SQL query against the tables (122) of database (118).

In the exemplary system of FIG. 1, the SQL module (116) receives SQL queries for execution from a host application (102). The host application (102) is a set of computer program instructions for user-level data processing that includes an embedded SQL query. The host application (102), for example, includes the following exemplary SQL query:
select*from stores, transactions
where stores.location=:CITY
and stores.storeID=transactions.storeID

In the example of FIG. 1, the exemplary SQL query above is a parameter of the ‘EXECUTE SQL’ preprocessor command that generates the computer program instructions for passing the exemplary SQL query above to the SQL module (116) for execution. The host application (102) passes the SQL queries to SQL module (116) through an application programming interface (‘API’) (109) of DBMS (106). DBMS (106) exposes DBMS API (109) to enable applications, such as, for example, the host application (102), to access modules of the DBMS, such as, for example, the SQL module (116). The DBMS API (109) may provide a command set for administering the DBMS (106) according any database connectivity specification as will occur to those of skill in the art such as, for example, ODBC or JDBC.

The exemplary SQL module (116) of FIG. 1 includes a parser (108) for parsing the SQL query. The parser (108) is implemented as computer program instructions that parse the SQL query. A SQL query is presented to SQL module (116) in text form as the parameters of a SQL command. Parser (108) retrieves the elements of the SQL query from the text form of the query and places them in a data structure more useful for data processing of a SQL query by SQL module (116).

In the exemplary system of FIG. 1, SQL module (116) includes access plan generator (112). The access plan generator (112) of FIG. 1 is a software component for creating an access plan for a SQL query. An access plan is a specification of the database operations and the sequence in which those operations are carried out for retrieving the results of a SQL query. Taking the following SQL query as an example:
select*from stores, transactions
where stores.storeID=transactions.storeID,
   the access plan generator (112) may generate the following exemplary access plan for the exemplary SQL query above:
tablescan stores
join to
index access of transactions

This access plan represents database operations that are carried out by primitive queries to the database. In the example above, the DBMS uses primitive queries to scan through the stores table and, for each stores record, join all transactions records for the store. The transactions for a store in the transaction table are identified through the ‘storeID’ field serving as a foreign key. The fact that a selection of transactions records is carried out for each store record in the stores table identifies the join function as iterative.

As the access plan generator (112) creates an access plan for a SQL query, the access plan generator (112) optimizes the access plan in dependence upon database statistics (126). Continuing with the exemplary access plan from above, the database statistics may reveal that there are only two values for ‘storeID’ in the transactions table—disclosing, therefore, that it is more efficient to scan the transactions table rather than using an index to locate records with a particular value for ‘storeID.’ Alternatively, database statistics may reveal that there are many transaction records with only a few transactions records for each value for ‘storeID’—disclosing that it is more efficient to access the transactions records by an index.

Database statistics are typically implemented as metadata of a particular database table, such as, for example, metadata of tables (122) of database (118). Database statistics (126) may include, for example:
Histogram statistics: a histogram range and a count of values in the range,
Frequency statistics: a frequency of occurrence of a value in a column, and
Cardinality statistics: a count of the number of different values in a column.

These three database statistics are presented for explanation only, not for limitation. The use of any database statistics as will occur to those of skill in the art is well within the scope of the present invention.

When the access plan generator (112) attempts to use databases statistics for a column of a table, for example, and discovers that particular database statistics are missing or stale, the access plan generator (112) notifies a statistics engine (128). The statistics engine (128) of FIG. 1 is a software component of the SQL module (116) that maintains database statistics (126) for the database (118). The statistics engine (128) generates any missing database statistics and updates database statistics that have become stale.

In the exemplary system of FIG. 1, the access plan generator (112) includes a set of computer program instructions for caching an access plan for a query according to embodiments of the present invention. The access plan generator (112) of FIG. 1 operates generally for caching an access plan for a query according to embodiments of the present invention by receiving a SQL query that specifies data for retrieval from a database, the SQL query characterized by one or more host variable values, generating an access plan in dependence upon the SQL query, calculating a routing code for the SQL query in dependence upon the host variable values of the SQL query and a portion of the database statistics (126), and storing the access plan in an access plan cache (130), including associating with the access plan the routing code for the SQL query and the portion of the database statistics (126) used to calculate the routing code.

The access plan cache (130) of FIG. 1 includes an access plan cache header table (132) for associating a SQL query's routing code and the portion of the database statistics (126) used to calculate the routing code with an access plan for the query. Each record of the access plan cache header table (132) includes fields for an access plan identifier (134), a SQL query (136), a routing code (138), and a database statistic vector (140). The access plan identifier (134) specifies an access plan stored in the access plan cache (130). The SQL query (136) represents the textual representation of the SQL query used to create the access plan specified by the associated identifier (134). The routing code (138) represents the routing code for the SQL query used to create the access plan specified by the associated identifier (134). The database statistics vector (140) represents a list of pointers to computer memory which store the portion of the database statistics (126) used to calculate the routing code for the associated SQL query (136).

The access plan generator (112) of FIG. 1 also operates generally for caching an access plan for a query according to embodiments of the present invention by receiving an additional SQL query characterized by one or more additional host variable values and determining whether to utilize the stored access plan for the additional SQL query in dependence upon the additional host variable values, the associated routing code, and the associated portion of the database statistics. In dependence upon the determination of whether to utilize the stored access plan for the additional SQL query, the access plan generator (112) of FIG. 1 also operates generally for caching an access plan for a query according to embodiments of the present invention by generating a new access plan for the additional SQL query.

After retrieving a stored access plan from the access plan cache (130) or generating a new access plan for a query, the SQL module (116) executes the access plan for the SQL query. In the exemplary system of FIG. 1, the exemplary SQL module (116) includes a primitives engine (114) implemented as computer program instructions that execute primitive query functions in dependence upon the access plan. A ‘primitive query function,’ or simply a ‘primitive,’ is a software function that carries out actual operations on a database, retrieving records from tables, inserting records into tables, deleting records from tables, updating records in tables, and so on. Primitives correspond to parts of an access plan and are identified in the access plan. Examples of primitives include the following database instructions:
retrieve the next three records from the stores table into hash table H1,
retrieve one record from the transactions table into hash table H2,
join the results of the previous two operations, and
store the result of the join in table T1.

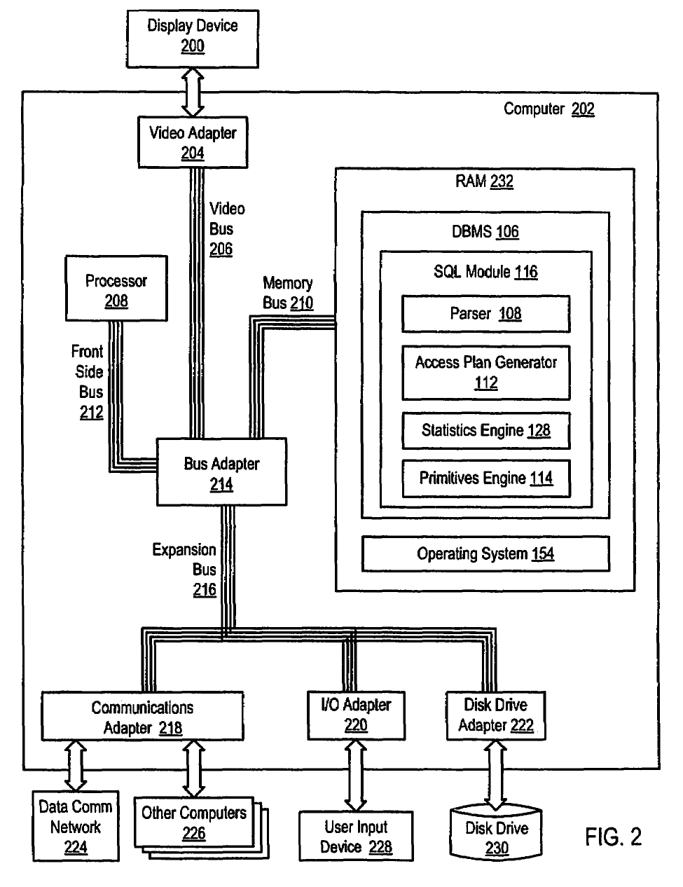

Caching an access plan for a query in accordance with the present invention in some embodiments may be implemented with a computer, that is, automated computer machinery. For further explanation, therefore, FIG. 2 sets forth a block diagram of automated computing machinery comprising an exemplary computer (202) useful in caching an access plan for a query according to embodiments of the present invention. The computer (202) of FIG. 2 includes at least one computer processor (208) or ‘CPU’ as well as random access memory (232) (‘RAM’) which is connected through a high speed memory bus (210) and bus adapter (214) to processor (208) and to other components of the computer (202).

Stored in RAM (232) is a DBMS (106). The DBMS (106) includes a SQL module (116), which in turn includes a parser (108), an access plan generator (112), a statistics engine (128), and a primitives engine (114). The DBMS (106), the SQL module (116), the parser (108), the access plan generator (112), the statistics engine (128), and the primitives engine (114) illustrated in FIG. 2 are software components, that is computer program instructions, that operate as described above with reference to FIG. 1.

Also stored in RAM (232) is an operating system (154). Operating systems useful in computers according to embodiments of the present invention include UNIX™, Linux™, Microsoft XP™, IBM's AIX™, IBM's i5/OS™, and others as will occur to those of skill in the art. The operating system (154), the DBMS (106), the SQL module (116), the parser (108), the access plan generator (112), the statistics engine (128), and the primitives engine (114) in the example of FIG. 2 are shown in RAM (232), but many components of such software typically are stored in non-volatile memory also, for example, on a disk drive (230).

The exemplary computer (202) of FIG. 2 includes bus adapter (214), a computer hardware component that contains drive electronics for high speed buses, the front side bus (212), the video bus (206), and the memory bus (210), as well as drive electronics for the slower expansion bus (216). Examples of bus adapters useful in computers useful according to embodiments of the present invention include the Intel Northbridge, the Intel Memory Controller Hub, the Intel Southbridge, and the Intel I/O Controller Hub. Examples of expansion buses useful in computers useful according to embodiments of the present invention may include Peripheral Component Interconnect (‘PCI’) buses and PCI Express (‘PCIe’) buses.

The exemplary computer (202) of FIG. 2 also includes disk drive adapter (222) coupled through expansion bus (216) and bus adapter (214) to processor (208) and other components of the exemplary computer (202). Disk drive adapter (222) connects non-volatile data storage to the exemplary computer (202) in the form of disk drive (230). Disk drive adapters useful in computers include Integrated Drive Electronics (‘IDE’) adapters, Small Computer System Interface (‘SCSI’) adapters, and others as will occur to those of skill in the art. In addition, non-volatile computer memory may be implemented for a computer as an optical disk drive, electrically erasable programmable read-only memory (so-called ‘EEPROM’ or ‘Flash’ memory), RAM drives, and so on, as will occur to those of skill in the art.

The exemplary computer (202) of FIG. 2 includes one or more input/output (‘I/O’) adapters (220). I/O adapters in computers implement user-oriented input/output through, for example, software drivers and computer hardware for controlling output to display devices such as computer display screens, as well as user input from user input devices (228) such as keyboards and mice. The exemplary computer (202) of FIG. 2 includes a video adapter (204), which is an example of an I/O adapter specially designed for graphic output to a display device (200) such as a display screen or computer monitor. Video adapter (204) is connected to processor (208) through a high speed video bus (206), bus adapter (214), and the front side bus (212), which is also a high speed bus.

The exemplary computer (202) of FIG. 2 includes a communications adapter (218) for data communications with other computers (226) and for data communications with a data communications network (224). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for caching an access plan for a query according to embodiments of the present invention include modems for wired dial-up communications, IEEE 802.3 Ethernet adapters for wired data communications network communications, and IEEE 802.11b adapters for wireless data communications network communications.

For further explanation, FIG. 3 sets forth a flow chart illustrating an exemplary method for caching an access plan for a query according to embodiments of the present invention. The method of FIG. 3 includes receiving (300), in a SQL module of a DBMS, a SQL query (302) that specifies data for retrieval from a database. The SQL query (302) of FIG. 3 represents a SQL query received in the DBMS from a host application. The SQL query (302) of FIG. 3 is characterized by one or more host variable values (304) and the database is characterized by database statistics (126). The SQL module may receive (300) the SQL query (302) according to the method of FIG. 3 as a call parameter for a function of a DBMS API invoked by a host application.

The method of FIG. 3 includes generating (306), by the SQL module, an access plan (308) in dependence upon the SQL query (302). The access plan (308) specifies the database operations and the sequence in which those operations are carried out for retrieving the results of the SQL query (302). The SQL module may generate (306) the access plan (308) according to the method of FIG. 3 by selecting various database operations to retrieve the data specified by the query (302) and optimizing the execution order of the database operations according to the database statistics (126).

The method of FIG. 3 also includes calculating (310), by the SQL module, a routing code (314) for the SQL query (302) in dependence upon the host variable values (304) of the SQL query (302) and a portion of the database statistics (126). The routing code (314) of FIG. 3 represents an identifier that categorizes the query (302), based on the query's host variable values (304), in one of a plurality of possible categories that apply to queries having matching textual representations and host variables. A SQL module may calculate (310) a routing code (314) for the SQL query (302) according to the method of FIG. 3 by calculating a category identifier (316) for each of the host variable values (304) of the query (302) and concatenating the category identifiers (316) into a single identifier used as the routing code (314) for the query (302). The SQL module may calculate category identifiers (316) for each host variable value (304) using a portion of the database statistics (126). In the example of FIG. 3, the portion of the database statistics (126) used to calculate the category identifiers (316) for the host variable values (304) includes frequent value tables (312) for table columns specified in the access plan (308) for the query (302). Using a frequent value table for a column, the SQL module may categorize a host variable value in the SQL query based on the distribution of the column values.

A frequent value table (‘FVT’) is a table derived from a single column in a table of the database that specifies the number of occurrences of all or a portion of the values in the column. Each entry in a frequent value table represents a value in the column and associates the value with the number of occurrences for the particular value in the column from which the FVT is derived. For further explanation, consider the following exemplary frequent value table derived from an exemplary column ‘COL’ in a table of a database:

Frequent
Value Table
For ‘COL’

| Values | Count |
|---|---|
| A | 200,000 |
| B | 500 |
| C | 450 |
| D | 430 |
| E | 400 |
| F | 380 |
| G | 8 |
| H | 3 |

The exemplary frequent value table above indicates that the value ‘A’ occurs 200,000 times in the column ‘COL,’ the value ‘B’ occurs 500 times in the column ‘COL,’ the value ‘C’ occurs 450 times in the column ‘COL,’ and so on. Readers will note that the exemplary frequent value table above is for explanation only.

As mentioned above, a SQL module may use a frequent value table to categorize a host variable value (304) in the SQL query (302) based on the distribution of possible column values for a host variable value. The number of possible categories into which a host variable may be categorized will depend on the distribution of values for a particular column. For example, a relatively even distribution in a particular column may be categorized using only a single category because the performance of access plans based on host variable values throughout the distribution remains relatively similar. A distribution that is skewed high or skewed low may, for example, be divided into two categories-one category for the average range portion of the distribution and second category for the skewed high portion of the distribution. Two categories may be used because the performance of access plans based on host variable values throughout the average range distribution may suffer if used when a query includes a host variable value in the skewed high or low portion of the distribution. A distribution that is skewed high and skewed low may, for example, be divided into three categories-one category for the middle-average range portion of the distribution, second category for the skewed high portion of the distribution, and third category for the skewed low portion of the distribution. Three categories may be used because the performance of access plans based on host variable values in one portion of the distribution may suffer if used when a query includes a host variable value in other portions of the distribution. The number of categories in which to divide a particular distribution may be calculated using well-known statistical and mathematical algorithms that may involve, for example, the standard deviation or the average of the distribution values.

For further explanation of categorizing the host variable values (304) using a frequent value table, consider again the exemplary frequent value table above. Using well-known statistical and mathematical algorithms, the distribution of values in the column from which the exemplary FVT is derived may generally divided into three broad categories: (1) a skewed high category identified by identifier ‘SH,’ (2) a average range category identified by identifier ‘AR,’ and (3) a skewed low category identified by identifier ‘SL.’ Using the exemplary categories, a SQL module may calculate a category identifier ‘SH’ for a host variable value of ‘A.’ A SQL module may calculate a category identifier ‘AR’ for host variable values ‘B.’ ‘C,’ ‘D,’ ‘E,’ and ‘F.’ A SQL module may calculate a category identifier ‘SL’ may be calculated for host variable values ‘G’ and ‘H.’ Because a frequent value table may not include all the column values for a column, a SQL module may assign a default value to the omitted values based on the distribution of the column values-perhaps, for example, either ‘AR’ or ‘SL.’ Readers will note of course that the exemplary category identifiers above are for explanation and not for limitation. Other category identifiers may also be useful in caching an access plan for a query according to embodiments of the present invention.

When the SQL query (302) is characterized by only one host variable value (304), the SQL module may used the category identifier (316) for that particular host variable value (304) as the routing code (314) for the SQL query (302). When the SQL query (302) is characterized by more than one host variable value (304), the SQL module may concatenate the category identifiers (316) for host variable values (304) into a single value that is used as the routing code (316) for the SQL query (302). For example, consider an exemplary SQL query embedded in a host application with two host variables ‘V1’ and ‘V2.’ The queries received in the SQL module from the host application have matching textual representations, but may have different host variable values. Further, consider that the distributions of possible column values for ‘V1’ and ‘V2’ are such that a host variable value may be categorized using a category identifiers ‘SH,’ ‘AR,’ or ‘SL’ as mentioned above. The possible routing codes for such an exemplary SQL query may include the following exemplary routing codes:

| Category IDs for | Category IDs for | |
|---|---|---|
| Host Variable | Host Variable | Routing |
| Values for ‘V1’ | Values for ‘V2’ | Code |
| SH | SH | SHSH |
| SH | AR | SHSH |
| SH | SL | SHSL |
| AR | SH | ARSH |
| AR | AR | ARAR |
| AR | SL | ARSL |
| SL | SH | SLSH |
| SL | AR | SLAR |
| SL | SL | SLSL |

Using the exemplary routing codes above, a SQL module may categorize a SQL query having potentially hundreds of thousands of possible host variable value combinations into one of nine possible categories. Calculating such routing codes for SQL queries are advantageous because the performance of an access plan created using a combination of host variable values that produces one routing code does not suffer so long as the access plan is used for an identical query characterized by a combination of host variable values that produces the same routing code. The performance of an access plan created using a combination of host variable values that produces one routing code, however, typically will suffer when the access plan is used for an identical query characterized by a combination of host variable values that produces the a different routing code.

In the example of FIG. 3 as described above, the routing code (314) includes category identifiers (316) for each of the host variable values (304) of the SQL query (302). That is, the routing code (314) described with reference to FIG. 3 is calculated by concatenating category identifiers calculated for each host variable value individually. Readers will note, however, that such a routing code implementation is for explanation and not for limitation. In fact, a routing code useful according to the present invention may be implemented in other ways as will occur to those of skill in the art such as, for example, a value calculated directly from the host variable values instead of concatenating category identifiers calculated for each host variable value individually.

The method of FIG. 3 also includes storing (318), by the SQL module, the access plan (308) in an access plan cache (130), including associating with the access plan (308) the routing code (314) for the SQL query (302) and the portion of the database statistics (126) used to calculate the routing code (314). The SQL module may associate the routing code (314) for the SQL query (302) and the portion of the database statistics (126) used to calculate the routing code (314) with the access plan (308) according to the method of FIG. 3 by storing, in a record of an access plan cache header (132), an access plan identifier (134) for the access plan (308), the textual representation of the SQL query (302), the routing code (314) for the SQL query (302), and a list of pointers to computer memory storing the frequent value tables (312) used to calculate the routing code (314).

The access plan cache (130) of FIG. 3 includes an access plan cache header table (132) for associating a SQL query's routing code and the portion of the database statistics (126) used to calculate the routing code with an access plan for the query. Each record of the access plan cache header table (132) includes fields for an access plan identifier (134), a SQL query (136), a routing code (138), and a database statistics vector (140). The access plan identifier (134) specifies an access plan stored in the access plan cache (130). The SQL query (136) represents the textual representation of the SQL query used to create the access plan specified by the associated identifier (134). The routing code (138) represents the routing code for the SQL query used to create the access plan specified by the associated identifier (134). The database statistics vector (140) represents a list of pointers to computer memory which store the portion of the database statistics (126) used to calculate the routing code for the associated SQL query (136).

In the method of FIG. 3, storing (318), by the SQL module, the access plan (308) in an access plan cache (130) includes storing (320), along with the access plan (308) in the access plan cache (130), the routing code (314) for the SQL query (302) and the portion of the database statistics (126) used to calculate the routing code (314). Storing (320) the routing code (314) for the SQL query (302) and the portion of the database statistics (126) used to calculate the routing code (314) along with the access plan (308) in the access plan cache (130) advantageously allows the SQL module to access all the data used to determine whether to reuse an access plan for an additional query from the access plan cache (130).

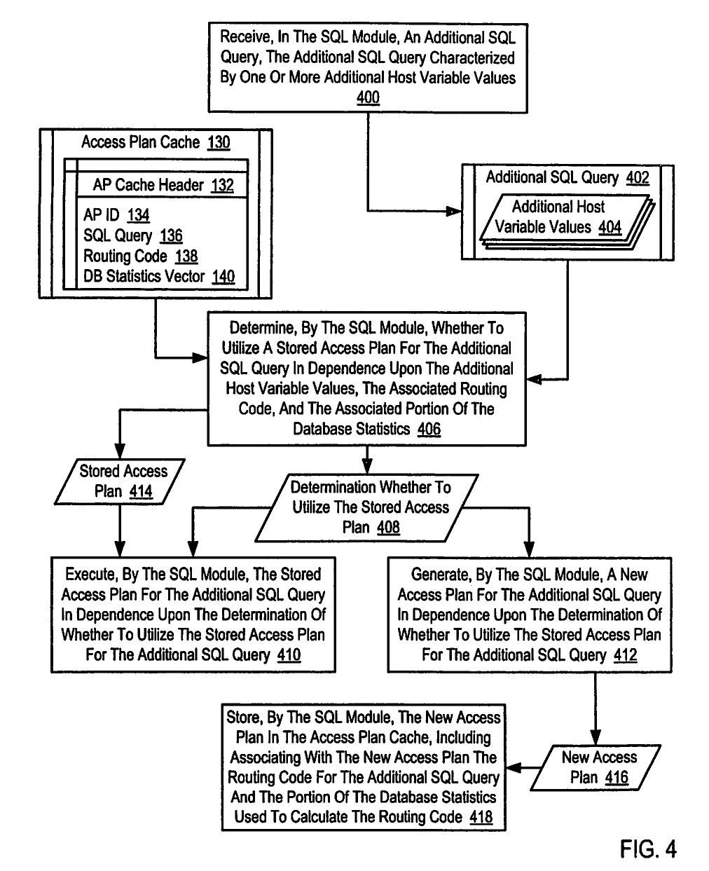

For further explanation, FIG. 4 sets forth a flow chart illustrating a further exemplary method for caching an access plan for a query according to embodiments of the present invention that includes receiving (400), in the SQL module, an additional SQL query (402) and determining (406), by the SQL module, whether to utilize the stored access plan for the additional SQL query (402). The additional SQL query (402) of FIG. 4 represents a SQL query received in the DBMS from a host application. The additional SQL query (402) is characterized by one or more additional host variable values (404). The SQL module may receive (400) the additional SQL query (402) according to the method of FIG. 4 as a call parameter for a function of a DBMS API invoked by a host application.

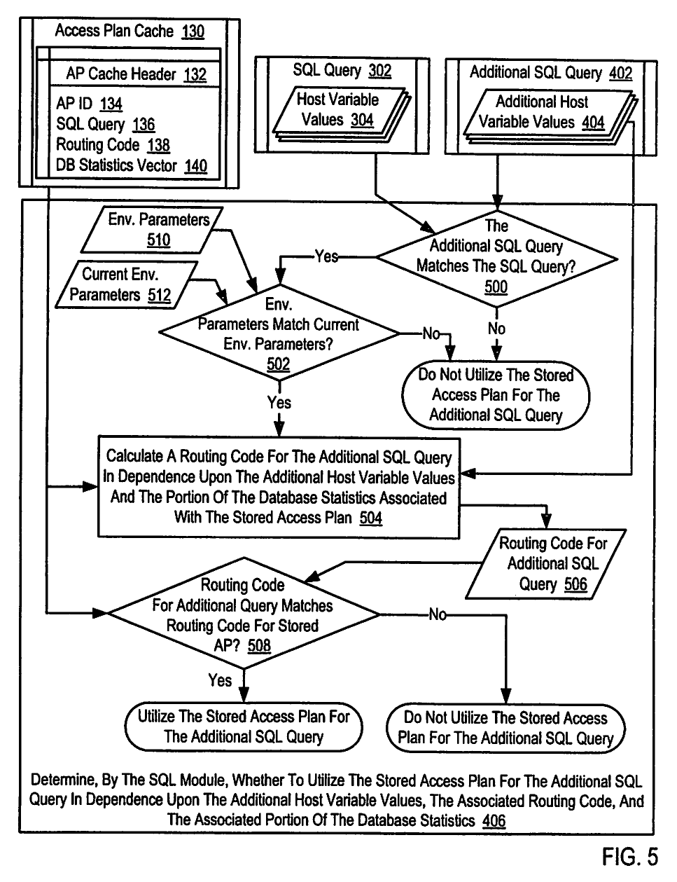

The method of FIG. 4 also includes determining (406), by the SQL module, whether to utilize a stored access plan (414) for the additional SQL query (402) in dependence upon the additional host variable values (404), the associated routing code for the stored access plan, and the associated portion of the database statistics used to calculated the routing code for the stored access plan. The stored access plan (414) of FIG. 4 represents an access plan stored in the access plan cache (130). The SQL module may determine (406) whether to utilize a stored access plan (414) for the additional SQL query (402) according to the method of FIG. 4 by determining whether the additional SQL query (402) matches the SQL query used to generated the stored access plan, determining whether environmental parameters for the database at the time the stored access plan was generated match current environmental parameters for the database if the additional SQL query matches the SQL query used to generated the stored access plan, calculating a routing code for the additional SQL query (402) in dependence upon the additional host variable values (404) and the portion of the database statistics associated with the stored access plan if the environmental parameters for the database at the time the stored access plan was generated match the current environmental parameters for the database, and determining whether the routing code for the additional SQL query matches the routing code associated with the stored access plan as discussed below with reference to FIG. 5.

The SQL module may determine (406) whether to utilize a stored access plan (414) for the additional SQL query (402) according to the method of FIG. 4 using any number of access plans stored in the access plan cache (130) provided that the stored access plans were generated for SQL queries that match the additional SQL query (402). The SQL module may store an indication of whether to utilize a stored access plan for the additional SQL query (402) in determination (408). The determination (408) may be implemented as a value stored in a Boolean flag. A value of TRUE may represent an indication by the SQL module to utilize the stored access plan for the additional SQL query (402), and a value of FALSE may represent an indication by the SQL module not to utilize the stored access plan for the additional SQL query (402).

The method of FIG. 4 includes executing (410), by the SQL module, the stored access plan (414) for the additional SQL query (402) in dependence upon the determination (408) of whether to utilize the stored access plan (414) for the additional SQL query (402). The SQL module may execute (410) the stored access plan (414) for the additional SQL query (402) according to the method of FIG. 4 by performing database operations in the order specified by the stored access plan (414) if the determination (408) indicates to utilize the stored access plan for the additional SQL query (402). Typically, the database operations are performed in the SQL module by a primitives engine as discussed above.

The method of FIG. 4 also includes generating (412), by the SQL module, a new access plan (416) for the additional SQL query (402) in dependence upon the determination of whether to utilize the stored access plan (414) for the additional SQL query (402). The SQL module may generate (412) a new access plan (416) for the additional SQL query (402) according to the method of FIG. 4 by selecting various database operations to retrieve the data specified by the additional SQL query (402) and optimizing the execution order of the database operations according to database statistics.

The method of FIG. 4 also includes storing (418), by the SQL module, the new access plan (416) in the access plan cache (130), including associating with the new access plan (416) the routing code for the additional SQL query (402) and the portion of the database statistics used to calculate the routing code for the additional SQL query (402). The SQL module may store (418) the new access plan (416) in the access plan cache (130) according to the method of FIG. 4 in a manner similar to storing the access plan in an access plan cache described above with reference to FIG. 3.

For further explanation of how a SQL module may determine whether to utilize the stored access plan for the additional SQL query described above with reference to FIG. 4, FIG. 5 sets forth a flow chart illustrating an exemplary method for determining (406), by the SQL module, whether to utilize a stored access plan for the additional SQL query (402) that is useful in caching an access plan for a query according to embodiments of the present invention. In the method of FIG. 5, the SQL module determines (406) whether to utilize a stored access plan for the additional SQL query (402) by determining (500) whether the additional SQL query (402) matches the SQL query (302) used to generate the stored access plan. The SQL query (302) of FIG. 5 is characterized by one or more host variable values (304), and the additional SQL query (402) is characterized by one or more additional host variable values (404).

The SQL module may determine (500) whether the additional SQL query (402) matches the SQL query (302) used to generate the stored access plan according to the method of FIG. 5 by comparing the textual representation of the additional SQL query (402) with the textual representation of the SQL query (302). If the textual representation of the additional SQL query (402) and the textual representation of the SQL query (302) are the same, then the additional SQL query (402) matches the SQL query (302). The textual representations of the queries will be same if the only differences between the queries are the host variable values—which is typically the case when the SQL module receives multiple queries as a result of a host application running the same embedded SQL statement multiple times.

In the example of FIG. 5, the additional SQL query (402) does not match the SQL query (302) if the textual representation of the additional SQL query (402) and the textual representation of the SQL query (302) are not the same. If the additional SQL query (402) does not match the SQL query (302), then the SQL module determines not to utilize the stored access plan generated using the SQL query (302) for the additional SQL query (402), and new access plan for the additional SQL query (402) is generated.

In the method of FIG. 5, the SQL module also determines (406) whether to utilize a stored access plan for the additional SQL query (402) by determining (502) whether environmental parameters (510) for the database at the time the stored access plan was generated match current environmental parameters (512) for the database if the additional SQL query (402) matches the SQL query (302). The environmental parameters (510) of FIG. 5 represent the policies used by the DBMS to manage a database at the time the stored access plan was generated. The environmental parameters (512) of FIG. 5 represent the policies currently used by the DBMS to manage a database. Examples of environmental parameters may include the maximum number of rows allowed in any table of the database, the database cache size, the location of certain database files in a file system, and so on.

The SQL module may determine (502) whether environmental parameters (510) match current environmental parameters (512) according to the method of FIG. 5 by comparing a timestamp indicating when the stored access plan was generated with a timestamp in a log table indicating the last time the any environment parameters for the database were altered. If the timestamp indicating when the stored access plan was generated specifies a time after the time specified by the timestamp in the log table indicating the last time the any environment parameters for the database were altered, then the environmental parameters (510) match the current environmental parameters (512). The environmental parameters (510), however, do not match the current environmental parameters (512) if the timestamp indicating when the stored access plan was generated specifies a time before the time specified by the timestamp in the log table indicating the last time the any environment parameters for the database were altered. Because not all environmental parameters may be relevant to the determination of whether the environmental parameters (510) match the current environmental parameters (512), the SQL module may incorporate a list of relevant environmental parameters in determining (502) whether environmental parameters (510) for the database at the time the stored access plan was generated match current environmental parameters (512) for the database. If the environmental parameters (510) for the database at the time the stored access plan was generated do not match the current environmental parameters (512) for the database, then the SQL module determines not to utilize the stored access plan generated using the SQL query (302) for the additional SQL query (402), and new access plan for the additional SQL query (402) is generated.

In the method of FIG. 5, the SQL module determines (406) whether to utilize a stored access plan for the additional SQL query (402) by calculating (504) a routing code (506) for the additional SQL query (402) in dependence upon the additional host variable values (404) and the portion of the database statistics associated with the stored access plan if the environmental parameters (510) for the database at the time the stored access plan was generated match the current environmental parameters (512) for the database. The SQL module may calculate (504) a routing code (506) for the additional SQL query (402) according to the method of FIG. 5 in a manner similar to calculating a routing code for the SQL query (302) as discussed above with reference to FIG. 3.

In the method of FIG. 5, the SQL module also determines (406) whether to utilize a stored access plan for the additional SQL query (402) by determining (508) whether the routing code (506) for the additional SQL query (402) matches the routing code associated with the stored access plan. If the routing code (506) for the additional SQL query (402) matches the routing code associated with the stored access plan, then in the example of FIG. 5 the SQL module determines to utilize the stored access plan generated using the SQL query (302) for the additional SQL query (402), and executes the stored access plan for the additional SQL query (402). If the routing code (506) for the additional SQL query (402) does not match the routing code associated with the stored access plan, however, then the SQL module determines not to utilize the stored access plan generated using the SQL query (302) for the additional SQL query (402), and new access plan for the additional SQL query (402) is generated.

Exemplary embodiments of the present invention are described largely in the context of a fully functional computer system for caching an access plan for a query. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of caching an access plan for a query, the method comprising:
receiving, in a SQL module of a DBMS, a SQL query that specifies data for retrieval from a database, the database characterized by database statistics, the SQL query characterized by one or more host variable values;
generating, by the SQL module, an access plan in dependence upon the SQL query;
calculating, by the SQL module, a routing code for the SQL query in dependence upon the host variable values of the SQL query and a portion of the database statistics; and
storing, by the SQL module, the access plan in an access plan cache, including associating with the access plan the routing code for the SQL query and the portion of the database statistics used to calculate the routing code.

2. The method of claim 1 wherein the portion of the database statistics used to calculate the routing code further comprises frequent value tables for table columns specified in the access plan.

3. The method of claim 1 wherein storing, by the SQL module, the access plan in an access plan cache, including associating with the access plan the routing code for the SQL query and the portion of the database statistics used to calculate the routing code further comprises storing, along with the access plan in the access plan cache, the routing code for the SQL query and the portion of the database statistics used to calculate the routing code.

4. The method of claim 1 further comprising:
receiving, in the SQL module, an additional SQL query, the additional SQL query characterized by one or more additional host variable values;
determining, by the SQL module, whether to utilize the stored access plan for the additional SQL query in dependence upon the additional host variable values, the associated routing code, and the associated portion of the database statistics; and
executing, by the SQL module, the stored access plan for the additional SQL query in dependence upon the determination of whether to utilize the stored access plan for the additional SQL query.

5. The method of claim 1 further comprising:
receiving, in the SQL module, an additional SQL query, the additional SQL query characterized by one or more additional host variable values;
determining, by the SQL module, whether to utilize the stored access plan for the additional SQL query in dependence upon the additional host variable values, the associated routing code, and the associated portion of the database statistics; and
generating, by the SQL module, a new access plan for the additional SQL query in dependence upon the determination of whether to utilize the stored access plan for the additional SQL query.

6. The method of claim 5 wherein determining, by the SQL module, whether to utilize the stored access plan for the additional SQL query in dependence upon the additional host variable values, the associated routing code, and the associated portion of the database statistics further comprises:
determining whether the additional SQL query matches the SQL query;
determining whether environmental parameters for the database at the time the stored access plan was generated match current environmental parameters for the database if the additional SQL query matches the SQL query;
calculating a routing code for the additional SQL query in dependence upon the additional host variable values and the portion of the database statistics associated with the stored access plan if the environmental parameters for the database at the time the stored access plan was generated match the current environmental parameters for the database; and
determining whether the routing code for the additional SQL query matches the routing code associated with the stored access plan.

7. The method of claim 1 wherein the routing code comprises category identifiers for each of the host variable values of the SQL query.

8. Apparatus for caching an access plan for a query, the apparatus comprising a computer processor, a computer memory operatively coupled to the computer processor, the computer memory having disposed within it computer program instructions capable of:
receiving, in a SQL module of a DBMS, a SQL query that specifies data for retrieval from a database, the database characterized by database statistics, the SQL query characterized by one or more host variable values;
generating, by the SQL module, an access plan in dependence upon the SQL query;
calculating, by the SQL module, a routing code for the SQL query in dependence upon the host variable values of the SQL query and a portion of the database statistics; and
storing, by the SQL module, the access plan in an access plan cache, including associating with the access plan the routing code for the SQL query and the portion of the database statistics used to calculate the routing code.

9. The apparatus of claim 8 wherein the portion of the database statistics used to calculate the routing code further comprises frequent value tables for table columns specified in the access plan.

10. The apparatus of claim 8 wherein storing, by the SQL module, the access plan in an access plan cache, including associating with the access plan the routing code for the SQL query and the portion of the database statistics used to calculate the routing code further comprises storing, along with the access plan in the access plan cache, the routing code for the SQL query and the portion of the database statistics used to calculate the routing code.

11. The apparatus of claim 8 further comprising computer program instructions capable of:
receiving, in the SQL module, an additional SQL query, the additional SQL query characterized by one or more additional host variable values;
determining, by the SQL module, whether to utilize the stored access plan for the additional SQL query in dependence upon the additional host variable values, the associated routing code, and the associated portion of the database statistics; and
executing, by the SQL module, the stored access plan for the additional SQL query in dependence upon the determination of whether to utilize the stored access plan for the additional SQL query.

12. The apparatus of claim 8 further comprising computer program instructions capable of:
receiving, in the SQL module, an additional SQL query, the additional SQL query characterized by one or more additional host variable values;
determining, by the SQL module, whether to utilize the stored access plan for the additional SQL query in dependence upon the additional host variable values, the associated routing code, and the associated portion of the database statistics; and
generating, by the SQL module, a new access plan for the additional SQL query in dependence upon the determination of whether to utilize the stored access plan for the additional SQL query.

13. The apparatus of claim 12 wherein determining, by the SQL module, whether to utilize the stored access plan for the additional SQL query in dependence upon the additional host variable values, the associated routing code, and the associated portion of the database statistics further comprises:
determining whether the additional SQL query matches the SQL query;
determining whether environmental parameters for the database at the time the stored access plan was generated match current environmental parameters for the database if the additional SQL query matches the SQL query;
calculating a routing code for the additional SQL query in dependence upon the additional host variable values and the portion of the database statistics associated with the stored access plan if the environmental parameters for the database at the time the stored access plan was generated match the current environmental parameters for the database; and
determining whether the routing code for the additional SQL query matches the routing code associated with the stored access plan.

14. The apparatus of claim 8 wherein the routing code comprises category identifiers for each of the host variable values of the SQL query.

15. A computer program product for caching an access plan for a query, the computer program product disposed in a signal bearing medium, the computer program product comprising computer program instructions capable of:
receiving, in a SQL module of a DBMS, a SQL query that specifies data for retrieval from a database, the database characterized by database statistics, the SQL query characterized by one or more host variable values;
generating, by the SQL module, an access plan in dependence upon the SQL query;
calculating, by the SQL module, a routing code for the SQL query in dependence upon the host variable values of the SQL query and a portion of the database statistics; and
storing, by the SQL module, the access plan in an access plan cache, including associating with the access plan the routing code for the SQL query and the portion of the database statistics used to calculate the routing code.

16. The computer program product of claim 15 wherein the signal bearing medium comprises a recordable medium.

17. The computer program product of claim 15 wherein the signal bearing medium comprises a transmission medium.

18. The computer program product of claim 15 wherein the portion of the database statistics used to calculate the routing code further comprises frequent value tables for table columns specified in the access plan.

19. The computer program product of claim 15 wherein storing, by the SQL module, the access plan in an access plan cache, including associating with the access plan the routing code for the SQL query and the portion of the database statistics used to calculate the routing code further comprises storing, along with the access plan in the access plan cache, the routing code for the SQL query and the portion of the database statistics used to calculate the routing code.

20. The computer program product of claim 15 further comprising computer program instructions capable of:
receiving, in the SQL module, an additional SQL query, the additional SQL query characterized by one or more additional host variable values;
determining, by the SQL module, whether to utilize the stored access plan for the additional SQL query in dependence upon the additional host variable values, the associated routing code, and the associated portion of the database statistics; and
executing, by the SQL module, the stored access plan for the additional SQL query in dependence upon the determination of whether to utilize the stored access plan for the additional SQL query.

21. The computer program product of claim 15 further comprising computer program instructions capable of:
receiving, in the SQL module, an additional SQL query, the additional SQL query characterized by one or more additional host variable values;
determining, by the SQL module, whether to utilize the stored access plan for the additional SQL query in dependence upon the additional host variable values, the associated routing code, and the associated portion of the database statistics; and
generating, by the SQL module, a new access plan for the additional SQL query in dependence upon the determination of whether to utilize the stored access plan for the additional SQL query.

22. The computer program product of claim 21 wherein determining, by the SQL module, whether to utilize the stored access plan for the additional SQL query in dependence upon the additional host variable values, the associated routing code, and the associated portion of the database statistics further comprises:
determining whether the additional SQL query matches the SQL query;
determining whether environmental parameters for the database at the time the stored access plan was generated match current environmental parameters for the database if the additional SQL query matches the SQL query;
calculating a routing code for the additional SQL query in dependence upon the additional host variable values and the portion of the database statistics associated with the stored access plan if the environmental parameters for the database at the time the stored access plan was generated match the current environmental parameters for the database; and
determining whether the routing code for the additional SQL query matches the routing code associated with the stored access plan.

23. The computer program product of claim 15 wherein the routing code comprises category identifiers for each of the host variable values of the SQL query.
